(19) United States
(12) Patent Application Publication
(10) Pub. No.: US 2006/0195567 A1
(43) Pub. Date: Aug. 31, 2006

(54) Networked cash dispensing system

(76) Inventors: Parin Mody, Wheaton, IL (US); Patrick Guardyak, McHenry, IL (US); Jason Krozel, Oak Park, IL (US); Colin Tysoe, Palatine, IL (US)

Correspondence Address: CUMMINS-ALLISON CORP.;C/O JENKENS & GILCHRIST, 225 WEST WASHINGTON STREET, SUITE 2600, CHICAGO, IL, 60606, US

(21) Appl. No.: 11/332,705

(22) Filed: Jan. 13, 2006

Related U.S. Application Data
(60) Provisional application No. 60/644,117, filed on Jan. 14, 2005.

(51) Int. Cl. G06F 15/173

(52) U.S. Cl. 709/224

(57) ABSTRACT

A networked cash dispensing system and a method for remote management of, and trend analysis for, networked cash dispensing systems is provided. The networked cash dispensing system comprises a casino transaction kiosk, a server, and a network. The casino transaction kiosk includes a central processing unit adapted to operate the kiosk and a local memory adapted to store information thereon. The server includes a database and management software that includes a data mining software portion and a user interface software portion therein. The data mining software portion is adapted to query the database. A network is adapted to allow the casino transaction kiosk and the server to communicate and to permit the transfer of information stored on the local memory of the casino transaction kiosk to the server. The management software is adapted to analyze this information. The management software allows for remote auto-impressing of the casino transaction kiosk.

### CROSS REFERENCE TO RELATED APPLICATIONS

This application claims the benefit of priority of U.S. Provisional Patent Application No. 60/644,117, filed Jan. 14, 2005, which is hereby incorporated by reference in its entirety.

### FIELD OF THE INVENTION

The present invention relates generally to a networked cash dispensing system and, more particularly, to a system and method for remote management of, and trend analysis for, networked cash dispensing systems.

### BACKGROUND OF THE INVENTION

Gaming terminals, such as slot machines, video poker machines and the like, have been a cornerstone of the gaming industry for many years. In recent years, the payouts associated with these type of machines has been shifting from a cash payout to paying out with an award ticket—due to the casino's desire to decrease or eliminate the labor and costs associated with coin based payout systems. A cash dispensing machine may then be utilized to redeem the award ticket for a cash payout, to credit the award to a player's player card, or to award vouchers or coupons to the player.

These cash dispensing machines provide a variety of alternative functions as well. For example, machines that provide self-service Player Point tracking, bill breaking, coupon redemption, and other functions allow casinos to automate a variety of otherwise time consuming processes, while offering players a more convenient means for conducting these transactions. Typically, a casino contains only one or two centrally located cashier's stations, whereas a number of machines can be distributed throughout the casino.

However, due to the increasing number of machines, problems arise with the management and placement of the machines. Additionally, the cash dispensing machines sitting on a casino floor require currency to be stored therein that can be distributed upon a player's request. However, until the cash is actually dispensed the cash is tied up by the machine and is useless to the casino. Thus, the ability of a casino to track and minimize the amount of dead cash is an important goal.

### SUMMARY OF THE INVENTION

According to one embodiment of the present invention, a networked cash dispensing system is provided. The networked cash dispensing system comprises a casino transaction kiosk, a server, and a network. The casino transaction kiosk includes one or more input and output that are adapted to receive and dispense documents. The casino transaction kiosk further includes a central processing unit adapted to operate the kiosk and a local memory adapted to store information thereon. The server includes a database and management software that includes a data mining software portion and a user interface software portion therein. The database is adapted to store information thereon. The management software is adapted to interact with the casino transaction kiosk. The data mining software portion is adapted to query the database. The network is in communication with the casino transaction kiosk and the server. The network is adapted to allow the casino transaction kiosk and the server to communicate and to permit a portion of the information stored on the local memory of the casino transaction kiosk to be transferred to the database of the server. The management software is adapted to analyze this information.

According to another embodiment of the present invention, a method for trend analysis within a casino network is provided. A casino transaction kiosk is coupled to the casino network. The casino transaction kiosk has one or more input and output that are adapted to receive and dispense documents. At least one of the one or more outputs is adapted to dispense a plurality of documents from a plurality of document-containing cassettes. The casino transaction kiosk further has a central processing unit adapted to operate the kiosk and a local memory adapted to store information thereon. The network is further coupled to a server having a database and management software including a data mining software portion and a user interface software portion therein. The database is adapted to store information thereon. The management software is adapted to interact with the casino transaction kiosk. The data mining software portion is adapted to query the database. The casino transaction kiosk and the server are communicatively coupled to each other via the network. The method comprises the act of transmitting information from the local memory of the casino transaction kiosk to the database on the server. The method further comprises the act of analyzing the transmitted information contained in the database to determine usage statistics over a duration of time for the casino transaction kiosk.

According to another embodiment of the present invention, a method for trend analysis within a casino network is provided for a system comprising a network comprising at least one casino transaction kiosk and at least one server, the casino transaction kiosk and the server being communicatively coupled via the network, the method comprising the act of transmitting information from a local memory of the casino transaction kiosk to a database on the server and the act of analyzing the transmitted information contained in the database to determine usage statistics over a duration of time for the casino transaction kiosk.

According to another embodiment of the present invention, a system and method for analyzing trends within a casino network is disclosed. The trend analysis is performed by a management software that includes a data mining software portion and a user interface software portion. The management software analyzes a database for information and presents one or more determined trends to a user based on the analyzed information. The one or more trends relate to one or more casino transaction kiosks comprising part of the casino network.

According to yet another embodiment of the present invention, a system and method for remote auto-impressing a casino transaction kiosk within a casino network is disclosed. A management software is provided that allows a user to remotely initiate an auto-impress procedure. The management software reduces or minimizes the human involvement with the impress procedure.

According to one embodiment of the present invention, a system and method for displaying a cable network feed on a casino transaction kiosk is disclosed. The casino transaction kiosk is provided with a coax-cable input that allows a coaxial cable to be attached thereto. The signal from the coaxial cable is directed through a television expander card that is used to relay the feed from the cable input to a video display located on the kiosk.

The above summary of the present invention is not intended to represent each embodiment, or every aspect, of the present invention. Additional features and benefits of the present invention are apparent from the detailed description, figures, and claims set forth below.

### BRIEF DESCRIPTION OF THE DRAWINGS

FIG. 1 is a perspective view of a casino transaction kiosk, according to one embodiment of the present invention.

FIG. 2 is a perspective view of the casino transaction kiosk of FIG. 1, in an open position.

FIG. 3 is a block diagram illustrating a control system that may be used in conjunction with the casino transaction kiosk of FIG. 1.

FIG. 4a is an architectural view of a casino network including a plurality of the casino transaction kiosks, according to one embodiment of the present invention.

FIG. 4b is an architectural view of the casino network of FIG. 4a divided into a plurality of zones, according to another embodiment of the present invention.

FIG. 5 is a block diagram of a plurality of server components located on the server of the casino network of FIG. 4a, according to one embodiment of the present invention.

FIG. 6 is a screen view of a main window of a management software, according to one embodiment of the present invention.

FIG. 7 is a screen view of the main window of FIG. 6 after adjusting the available operations for a user, according to one embodiment of the present invention.

FIG. 8 is a screen view displaying the located devices on the casino network of FIG. 4a, according to one embodiment of the present invention.

FIG. 9 is a screen view displaying the status of one of the located devices displayed in FIG. 8, according to one embodiment of the present invention.

FIG. 10 is a screen view displaying the located zones on the casino network of FIG. 4b, according to one embodiment of the present invention.

FIG. 11 is a screen view displaying the devices located within one of the zones displayed in FIG. 10, according to one embodiment of the present invention.

FIG. 12 is a screen view displaying a plurality of report-type options within the main window of FIG. 6, according to one embodiment of the present invention.

FIG. 13 is a screen view displaying a list of the historical transactions of a device within the main window of FIG. 6, according to one embodiment of the present invention.

FIG. 14 is a screen view displaying the selection options for devices within the casino network of FIG. 4a to be configured, according to one embodiment of the present invention.

FIG. 15 is a screen view displaying a plurality of configuration operation buttons, according to one embodiment of the present invention.

FIG. 16 is a screen view displaying a fields-based editor of the management software, according to one embodiment of the present invention.

FIG. 17 is flowchart of a method for remote auto-impressing a device located on the casino network of FIG. 4a, according to one embodiment of the present invention.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents and alternatives falling within the spirit and scope of the invention as defined by the appended claims.

### DESCRIPTION OF THE ILLUSTRATED EMBODIMENTS

Casinos desire an efficient and analytic way to determine what areas within the casino are best suited to place cash dispensing machines and how many should be placed within each area. Because the players are increasingly relying on the cash dispensing machines, casinos desire to be notified quickly when a machine requires attending or maintenance. Further, casinos desire these machines to be operable on the casino's existing network and manageable by existing personnel that monitor the devices connected to the network.

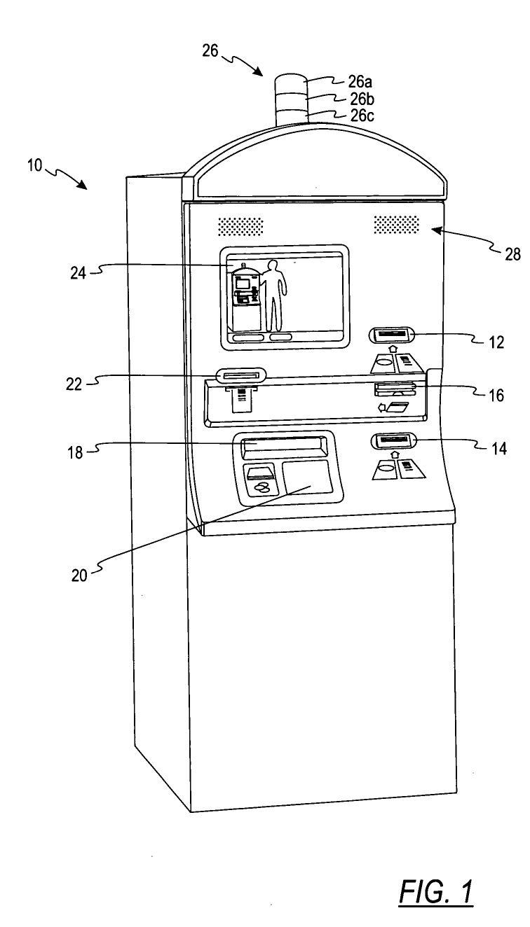

FIG. 1 is a perspective view of a Casino Transaction Kiosk (CTK) 10, according to one embodiment of the present invention. The CTK 10 includes a plurality of input devices, such as, document acceptors 12 and 14, as well as card reader 16. The acceptors 12, 14 are adapted to receive both currency and documents that include a bar code, such as casino payout tickets or promotional coupons. According to some embodiments, when a currency note is inserted into either acceptor 12, 14, an evaluation device (not shown) determines both the authenticity and denomination of the inserted note. Examples of various evaluation devices and/or sensors are more fully detailed in, for example, U.S. Pat. Nos. 5,295,196; 5,467,405; 5,633,949; 5,640,463; 5,652,802; 5,790,693; 5,790,697; 5,815,592; 5,870,487; 5,905,810; 5,966,456; 5,992,601; 6,012,565; 6,220,419; 6,237,739; 6,241,069; 6,363,164; 6,539,104; 6,560,355; 6,661,910, and PCT Patent Publication No. WO 91/11778, each of which is incorporated herein by reference in its entirety, it being understood that the various evaluation devices and sensors described in the above patents and applications are mentioned by way of example and not by way of limitation and it being understood that those skilled in the art are aware of many, many other sensors and/or methods of processing and making judgments about currency bills and other documents. According to some embodiments, the evaluation device is adapted to also determine the authenticity and value of a payout ticket, such as by scanning a bar code located thereon. Some examples of evaluation devices and/or sensors for analyzing bar code containing documents are more fully described in, for example, U.S. Pat. Nos. 6,778,693 and 6,843,418, each of which is incorporated herein by reference in its entirety, it being understood that the various evaluation devices and sensors described in the above patents are mentioned by way of example and not by way of limitation and it being understood that those skilled in the art are aware of many, many other sensors and/or methods of processing and making judgments about bar-coded documents. According to one embodiment, the CTK 10 communicates with a remote ticket host via a protocol dictated by the casino. According to one embodiment, the remote ticket host provides the value or amount associated with the scanned bar code. The bar code may be used, for example, to indicate the payout amount awarded from a particular gaming machine within a casino.

According to the illustrated embodiment, the CTK 10 is provided with a plurality of document acceptors 12, 14. By utilizing multiple document acceptors (each having an accompanying document acceptor box or input bin) the document capacity of the CTK 10 may be increased. Additionally, utilizing multiple document acceptors increases the reliability of the CTK 10 by providing redundant systems for player transactions. However, in other embodiments of the present invention, a single document acceptor is used. In yet other embodiments of the present invention, a first document acceptor is provided specifically for currency documents, while the second document acceptor is provided solely for ticket redemption.

The card reader 16 may be utilized to read a player's “player card” or other magnetic card. Currently, player cards are used by casinos to reward certain players with complimentary services or special offers. For example, a player may be enrolled in the casino's players' club and may be awarded certain complimentary services as that player collects points in the player's player-tracking account. The player inserts the player's card into the card reader 16, which allows the casino's computers to retrieve his or her information. The player may swipe their player card through the card reader 16 and may then be prompted to enter their personal PIN before being allowed to access his or her information.

In addition to card reader 16, an additional card reader may be incorporated into the CTK 10 for reading a smart card. A smart card is a plastic card about the size of a credit card-with an embedded microchip that can be loaded with data—used for electronic cash payments, and other applications, and then periodically refreshed for additional use. A smart card contains more information than a magnetic stripe card and it can be programmed for different applications. Some cards can contain programming and data to support multiple applications and some can be updated to add new applications after they are issued. Smart cards can be disposable though typically they are designed to be reloadable.

The CTK 10 also includes a plurality of output devices, such as, cash dispenser 18, coin dispenser 20, and ticket dispenser 22. The cash and coin dispensers 18, 20 provide currency bills and coins to players when a player inserts a document into either of the acceptors 12, 14. For example, if a player inserts a $100 currency bill into the document acceptor 12, in some embodiments the bill will be broken into smaller bills and/or coins depending on the breakdown that is specified by the player or the casino. The bills and/or coins may then be provided to the player via the cash and coin dispensers 18, 20. Alternatively, the player may insert a payout ticket or similar document into one of the acceptors 12, 14 and then be provided with the cash value of the payout ticket via the cash and coin dispensers 18, 20.

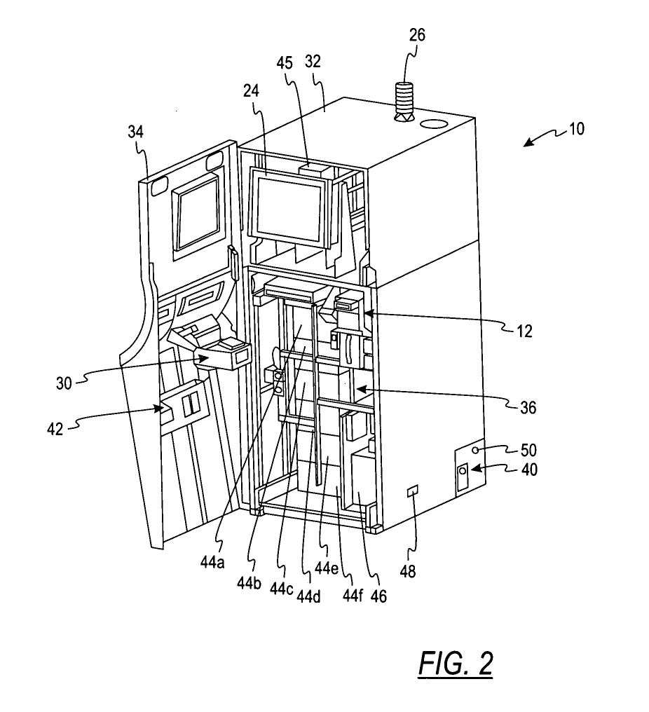

The ticket dispenser 22 may be used to dispense tickets and/or coupons to players utilizing the CTK 10. The ticket dispenser 22 includes a printer 30 (FIG. 2) for printing the ticket or coupon to be dispensed. A player may be issued a ticket or coupon when a requisite number of player points are earned, for example. The ticket or coupon may be valid for use in the casino only or, in other embodiments, may be used outside of the casino. In still other embodiments, the ticket or coupon may be utilized both within or outside of the casino. A ticket or coupon may also be issued when a large bill is broken, when a payout ticket's award includes a ticket or coupon being issued, or when the player requests a ticket or coupon in exchange for currency.

The CTK 10 also comprises a display, such as video display 24, for communicating information to a player. The video display 24 may include a touch screen that overlays the video display 24 to allow players to make transaction related selections. In some embodiments of the present invention, the video display 24 includes an animated hostess that guides the player through the transactions via the touch screen and video display 24. When the CTK 10 is not in use by a player, the casino may utilize the video display 24 to display advertising or other messages to the casino's patrons. The video display 24 is adapted to support custom graphics and messages via scheduled or direct video advertising.

The CTK 10 is also provided with a warning light 26, which may include a plurality of lights 26a-c. The warning light 26 may be used to indicate to the casino operators and players that a particular machine is out of service or is low on currency. The warning light 26 may also be used to draw attention to the machine while advertisements are being displayed on the video display 24 or to assist players in locating the CTK 10. The CTK 10 may also include one or more speakers 28 for communicating audio information to a player. For example, the speakers 28 may be utilized in conjunction with the video display 24 to guide players through transactions on the CTK 10. Additionally, the speakers 28 may be used to draw attention to the CTK 10 while advertisements or promotions are being displayed.

Referring also to FIG. 2, the internal compartment 36 of the CTK 10 is illustrated according to one embodiment of the present invention. The internal compartment 36 is formed by a housing 32 and a door 34 which pivots on the housing 32 between a closed position (FIG. 1) and an open position (FIG. 2). As illustrated in FIG. 2, the CTK 10 is in a front-loading arrangement with the door 34 being attached to the front of the housing 32. In other embodiments, the CTK 10 may be in a rear-loading arrangement with the door being attached to the rear of the housing.

The housing 32 is provided with a power input 40, such as a receptacle for receiving a power cord, for supplying electricity to the CTK 10 to power the various components. An Uninterruptible Power Supply (UPS) 46 is also provided and allows the CTK 10 to operate for at least a short time if the power supply to the power input is interrupted. The UPS 46 contains a battery that “kicks in” when the UPS 46 senses a loss of power from the primary input. Software is included within the CTK 10 that automatically backs up (saves) any data or transactions that are being processed by the CTK 10 when the UPS 46 becomes activated. Additionally, or alternatively, the UPS 46 allows the CTK 10 to complete the transaction that is being processed when the UPS 46 is activated. Thus, the CTK 10 is able to save any data or complete any transaction that is being processed and exit gracefully before the secondary power source (the battery) runs out, which prevents players from losing their money, player's points, payout tickets, tickets, coupons, or other documents and information.

The CTK 10 also includes an attendant control panel 42 for allowing an attendant to interact with the CTK 10 for maintenance and machine balancing. The attendant control panel 42 includes an attendant display and an input device, such as, a plurality of push buttons or a touch screen that overlays the attendant display. A network port 48 is incorporated into the CTK 10 to allow the CTK 10 to be connected to a network via a network cable. In alternative embodiments, the network port 48 allows for wireless connection to the network.

The CTK 10 further includes a plurality of cassettes 44a-f for storing a plurality of currency bills or other documents. The cassettes 44a-f are in communication with the cash dispenser 18 via one or more transport paths (not shown). The CTK 10 also is provided with one or more coin hoppers 45 that may be positioned behind the video display 24 in FIG. 2. According to some embodiments, the coin hopper 45 is reloadable from the top and dispenses coins through the lower portion to be distributed by the coin dispenser 20.

In some embodiments, including the embodiment illustrated in FIG. 2, the CTK 10 may include a coax-cable input 50 for allowing the CTK 10 to be connected to a coax cable, such as a cable television cable. The video display 24 may then be used to display one of the channels provided by the television cable. The channel may be displayed on the video display 24 when the CTK 10 is idle, or may be displayed on a part of the screen or in the background when the CTK 10 is being utilized.

According to some embodiments, a player begins a transaction with the CTK 10 by inserting a document into one of the document accepters 12, 14 or by sliding their players' card through card reader 16. The player is then prompted by the video display 24 throughout the transaction. The player may choose, for example, to break the inserted currency into smaller currency, exchange the ticket or coupon for currency, credit the currency or ticket value to their players' card, etc. The player may also utilize the CTK 10 to inquire as to the number of credits or value of the inserted players' card or may request a coupon or other document. Once the player has completed the transaction a receipt may be issued to the player, in some embodiments, from the printer 30.

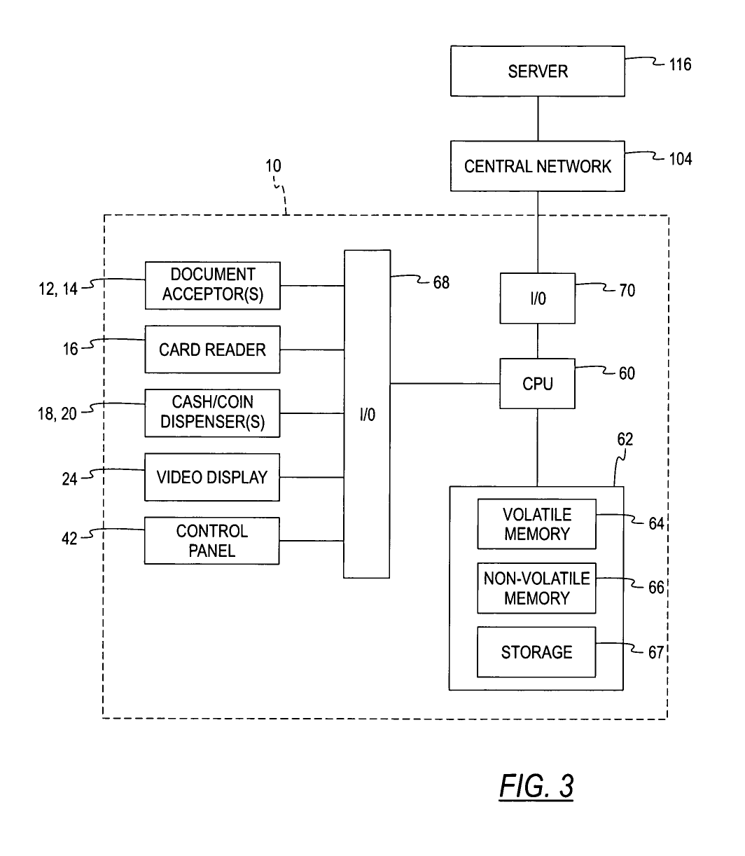

Referring also to FIG. 3, the various components of the CTK 10 are controlled by a central processing unit (CPU) 60 (such as a microprocessor or microcontroller). It should be understood by those skilled in the art that the CPU 60 may include a plurality of microprocessors and/or microcontrollers. The CPU 60 is communicatively coupled to or includes a local memory 62. The local memory 62 may comprise a volatile memory 64 (e.g., a RAM), a non-volatile memory 66 (e.g., an EEPROM, SRAM, etc.), and a storage 67 (e.g., a hard disk). The local memory 62 may include multiple memory devices.

According to some embodiments, the local memory 62 maintains a Day transaction database, whereby all of the transactions and associated CTK events are logged to the local memory 62 for storage and future operations. According to some embodiments, the local memory 62 stores an Active Server Page (ASP) that processes user requests input via the video display 24 or remote access tool, such as a web browser. The ASP searches the local memory 62 (of the same CTK 10, any other CTK 10 located on the network, or server 116) for the requested information, and formats and presents the content to the user via the video display 24 or remote access tool.

According to some embodiments, the various components of the CTK 10 communicate with the CPU 60 through input/output (I/O) circuits 68. In this manner, the CPU 60 is able to receive inputs from and control the peripheral components of the CTK 10. In embodiments where a coax-cable input 50 is provided, a television expander card may be provided so that the CPU 60 is able to receive inputs from and control through the I/O circuits 68. The television expander card is used to relay the feed from the cable input 50 to the video display 24.

In addition, the CPU 60 communicates with external systems via the I/O circuits 70. Although the I/O circuits 68, 70 are illustrated as a single block, it is understood by those skilled in the art that the I/O circuits 68, 70 may include a number of different types of I/O circuits.

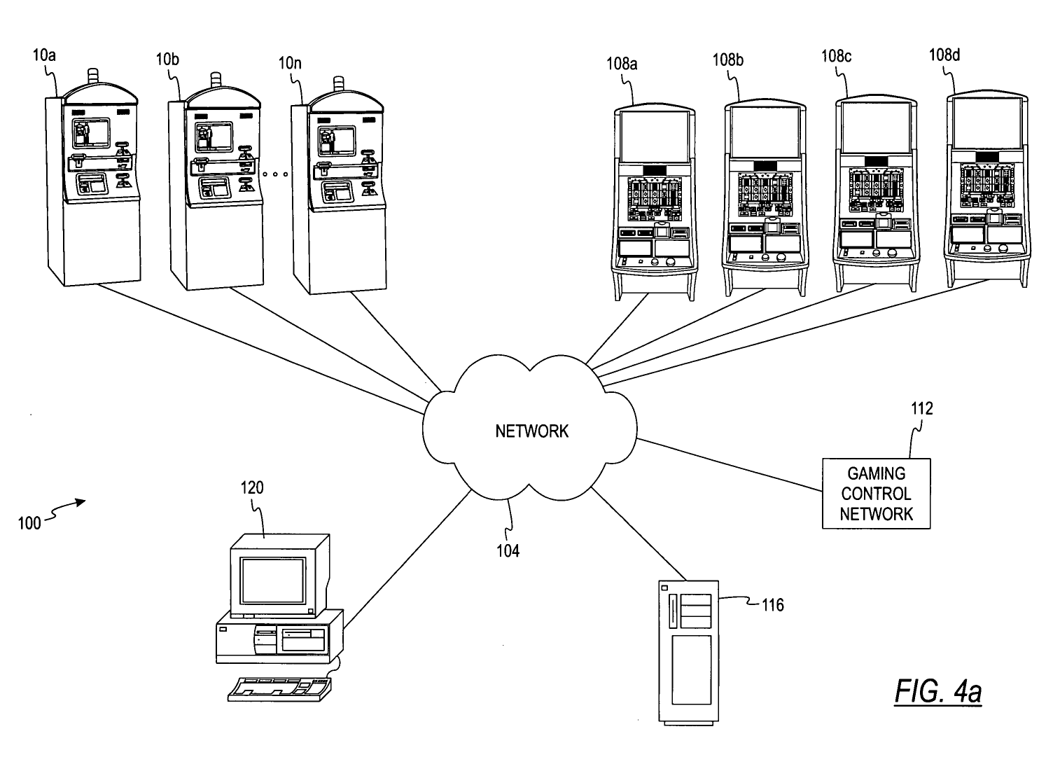

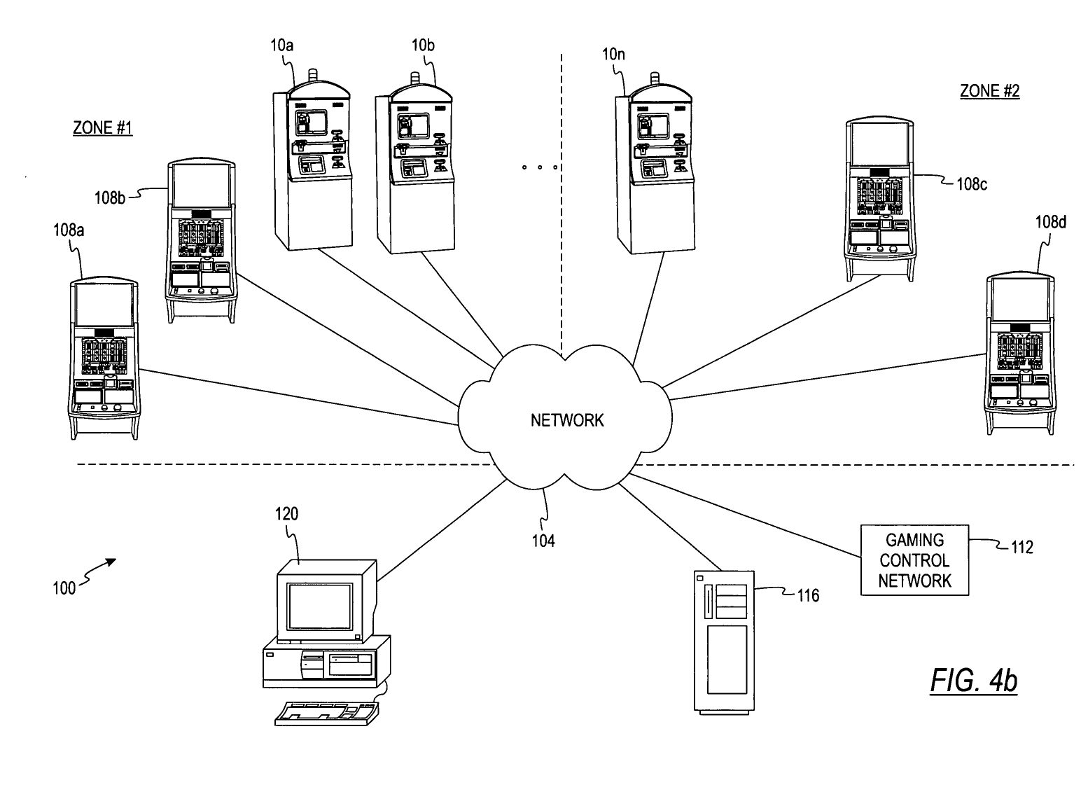

The CTK 10 is typically operated as part of a casino network 100 (FIG. 4) having a server 116 in communication with a network 104. A plurality of CTKs 10 are coupled to the network 104. The CPU 60 is able to communicate with the server 116 (and other CTKs 10) via the network 104. According to some embodiments, the CPU 60 communicates with the server 116 using Transmission Control Protocol/Internet Protocol (TCP/IP) language utilizing the Ethernet for LAN clients. Thus, the CPU 60 can transfer a portion of the contents of the local memory 62 (e.g., usage info, documents dispensed, inputs received, system failures, etc.) to the server 116 for storage in a database associated therewith. In addition, the software located on the server 116 may prompt the CPU 60 for specific information or may cause the CPU 60 to run a specific routine.

For example, at the close of a business “Day,” the server 116 may prompt the CPU 60 to run a balance routine, wherein the transactional data from the CTK 10 is sent to the server 116 in addition to updating the CTK's 10 own local memory 62. For the purposes of this application, a “Day” is defined as the duration of time between the opening and closing of a business period and may consist of multiple calendar days. At the close of a Day, the casino balances its records to ensure that its financial information is accurate. Thus, the casino needs to be informed of the financial transaction data that has been transacted on the CTK 10 for that Day.

Turning now to FIGS. 4a-b, an example of a casino network 100 is illustrated according to one embodiment of the present invention. The casino network 100 includes a plurality of CTKs 10a-n in communication with a network 104. Any plurality of CTKs 10 can be connected to the network 104 until the maximum capacity of the network has been achieved. The network 104 is typically a Local Area Network (LAN) operated by the individual casino. However, the network 104 is not limited to a LAN, and instead may be a Wide Area Network (WAN) or other type of network. A plurality of gaming machines, such as slot machines 108a-d, may also be in communication with the network 104. Typically, a gaming control network 112 is used to operate the individual gaming machines via the network 104.

The plurality of CTKs 10a-n and/or the slot machines 108a-d may be grouped into a plurality of zones. As illustrated in FIG. 4b, the plurality of CTKs 10a-n and the slot machines 108a-d are separated into to distinct zones. The first zone comprises slot machines 108a and 108b along with CTKs 10a and 10b. The second zone comprises slot machines 108c and 108d along with CTK 10n. A zone may contain any number of CTKs 10, gaming machines, and other devices, and may comprise a grouping of devices based on any number of ways, such as, for example, based on geographical placement, device type, etc.

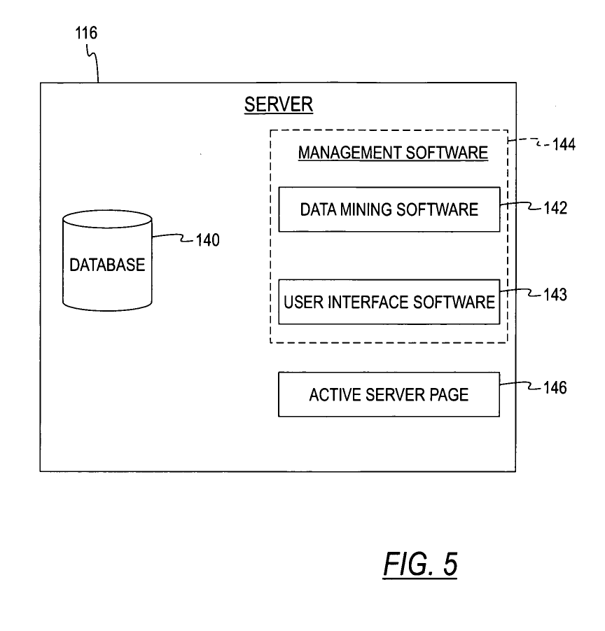

A server 116 is located on the network 104 and is in communication with the CTKs 10a-n via the network 104. As will be explained in greater detail with respect to FIG. 5, the server 116 includes a database and software that can be utilized by the casino to extract various information and trends from the CTKs 10a-n located within the casino network 100. In addition, the server 116 may include the software required to operate the network 104 and the various components located thereon, or a separate server may be used to provide this functionality.

One or more computers 120 or similar devices may be located on, or connected to, the network 104 as well. Alternatively, the computer 120 may be located outside of the LAN but may gain access from outside of the network, such as via the internet. The computer 120 may be used to gain access to the information stored on the server 116 that was transmitted by the CTKs 10a-n. The computer 120 may be used by casino employees—having the proper access—to view and manipulate the stored data and other information for the CTKs 10a-n individually or as a whole.

According to some embodiments, the server 116 communicates with the network 104 using TCP/IP language utilizing the Ethernet for LAN clients. WAN clients may be supported through connection into an intranet or a Point-to-Point Protocol (PPP) via a serial interface, such as a dial-up connection.

Referring also to FIG. 5, the server 116 includes a database 140 for storing information communicated thereto by the CPU 60 of the CTKs 10a-n. The information stored in the database 140 is accessible via a data mining software 142 that may also be stored on the server 116. Typically, the data from the CTK's 10a-n is transmitted and stored utilizing a proprietary encryption/decryption scheme. The data mining software 142 includes the decryption scheme for allowing a casino employee to access the data that is stored within the database 140. Upon a request by a casino employee-having the proper access-the data mining software 142 translates the encrypted data into a readable and/or graphical format and transmits this information to the employee. The server 116 also contains user-interface software 143 that provides an interface between the CTKs 10a-n and the computer 120. The data mining software 142 and the user-interface software 143 act in conjunction and form the management software 144 that is installed on the server 116. The management software 144 may be used to find, read, and present data stored in the database 140 to a user. As used below, management software 144 is used to describe both software portions.

The management software 144 provides the ability to (i) monitor the CTK's 10a-n for current operational status, (ii) query system reports, (iii) allow for asynchronous system fault reporting, (iv) enable and disable the various transaction types supported by the CTK 10, and (v) perform maintenance from an external device, such as computer 120. In some embodiments, the management software 144 provides a high degree of system integrity, especially in the areas of security and data storage. For example, in some embodiments, only the Information Technology (IT) department within the casino has the appropriate privileges to access the database 140 on server 116 or storage 67 on the CTK 10. In addition, redundancy in the storage of data is provided by maintaining information within the storage 67 of the CTK 10 as well as within the database 140 of the server 116. Thus, if the CTK 10 becomes non-functional, the data for the transactions completed by the CTK 10 can be retrieved from the database 140. In some embodiments, the storage 67 of the CTK 10 is set to purge data after it has been stored for ninety Days while the server 140 is set to store data indefinitely or purge after a longer period of time.

In some embodiments, the management software 144 is fault tolerant, whereby the interaction of user operations will not cause a functional device to become inoperative. In some embodiments, the management software 144 communicates via an Extensible Markup Language (XML) protocol. All commands and messages received and transmitted by the management software 144 are validated via an XML parser. This type of validation scheme helps prevent both users and third-party systems from causing a functional CTK 10 to become inoperative.

The management software 144 is programmed so as to allow the management software 144 to be accessed and utilized via a standard web browser. As such, according to some embodiments, the management software 144 is designed to be utilized by a user using Microsoft's Internet Explorer or Netscape's Navigator browsers. The server 116 includes an Active Server Page (ASP) 146 that provides device independent functionality. In some embodiments, the ASP 146 resides on both the server 116 and the CTK 10. Utilizing a browser on the computer 120, a user, having the appropriate privileges, can direct the browser to either the server's ASP 146 or the CTK's 10 ASP. According to some embodiments, the ASP 146 processes a user request from the computer 120, accesses one or more of the CTK's 10a-n (or the database's 140) immediate or historical data, and formats and presents the content to the user via the user's web browser. The ASP 146 uses input received as the result of the user's request to access data from the local memory 62 or the database 140 and then builds or customizes the page on the fly before sending it to the user in a form that can be presented by the user's web browser. In this manner, the ASP 146 is able to provide both the proper data and operational controls to the user in a device transparent mode. Thus, a user is able to gain access to the information located on the database 140 via the use of operations initiated from the management software 144 using, for example, Structure Query Language (SQL).

The management software 144 allows for local monitoring of the CTKs 10a-n. Local monitoring is the monitoring of the CTKs 10a-n from within a LAN. According to some embodiments, a user is able to monitor a single CTK 10a or multiple CTKs 10a-n within the LAN via any LAN connection point having a standard web browser. The management software 144 also allows for remote monitoring of the CTKs 10a-n within the scope of a WAN or other network. Similar to LAN monitoring, a user is able to monitor one or more CTKs 10a-n within the network 100 via any WAN connection point having a standard web browser.

In some embodiments, the management software 144 facilitates the creation of real-time and historical management reports from one or more of the CTKs 10a-n. In some embodiments, a user may query the database 140 via the management software 144 for real-time management reports that reflect the system totals from the current Day or transaction. Additionally, in some embodiments, a user may query the database 140 for historical management reports that reflect totals from closed Days or previous transactions. The database 140 maintains historical data for the CTK's 10a-n. A user having the appropriate privileges can set a time period (e.g., 6 months, 1 year, etc.) after which the stored data will be purged from the database 140.

According to some embodiments, each transaction processed by a CTK 10 is provided a transaction number that identifies the specific transaction. The management software 144 allows a user to track a transaction number back to one of the CTKs 10a-n on the casino network 100 from which it was processed.

In addition, in some embodiments the management software 144 provides bar code support for the CTKs 10a-n. As discussed above, in some embodiments the CTK 10 accepts and dispenses various documents that include bar codes. According to some embodiments, the management software 144 assists with bar code tracking while providing an interface to third-party transaction processors for bar code generation and processing. Thus, when a bar code is to be dispensed from the CTK 10, the management software 144 communicates with a third-party bar code generating device to determine what bar code should be printed and dispensed.

According to some embodiments, the management software 144 further supports the configuration of one or more of the CTKs 10a-n over the casino network 100. Configuration changes may be applied immediately or at a scheduled time depending on the user or system specifications. According to some embodiments, the management software 144 allows the user to revert to a prior configuration, modify a prior or current configuration, or create a new configuration. A backup of the configuration can be stored locally in the local memory 62 of the CTK 10, on the server 116, on a remote server, or to external media such as a flash card. According to some embodiments, the management software 144 also supports software updates on the server 116, including database management utilities. At the same time, in some embodiments, the management software 144 supports software updates on one or more of the CTKs 10a-n.

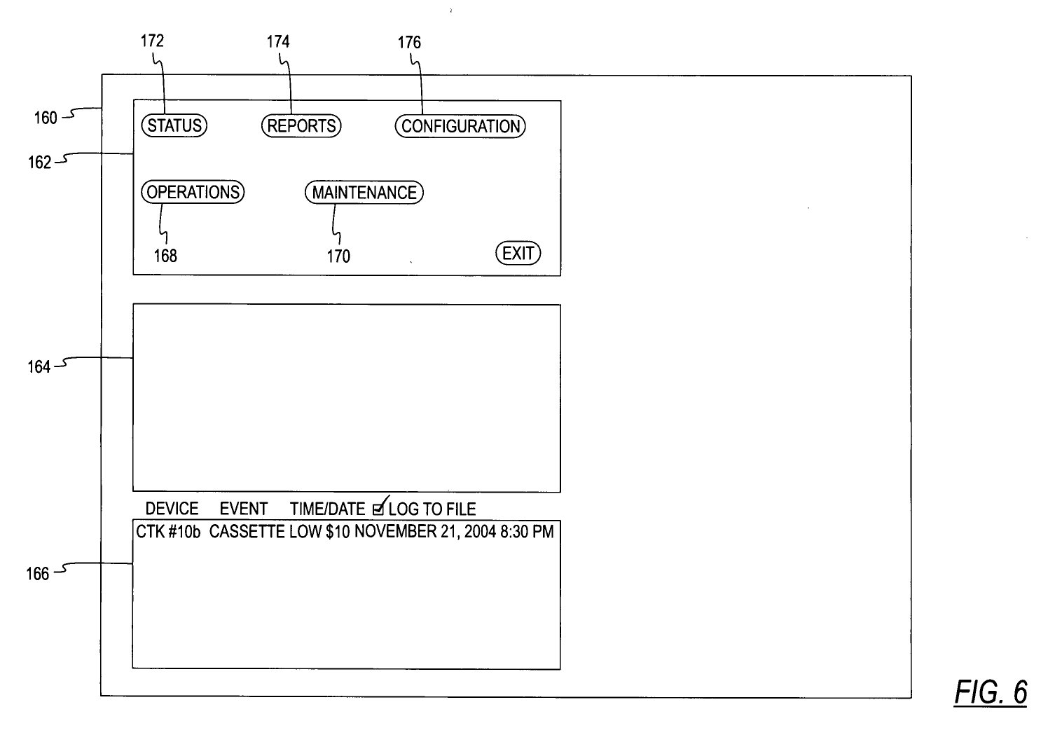

Referring now to FIGS. 6-17, the usage of the management software 144 by a user will be illustrated. It should be understood that the various screen views represent only some embodiments of the present invention and that other screen layouts and designs may be utilized in accordance with the present invention. The various screen views are meant to represent the general information and functionality presented to a user utilizing a browser on the computer 120.

FIG. 6 illustrates the main window 160 of the management software 144. The main window 160 includes a plurality of functional areas, such as an operations screen area 162, an information screen area 164, and an Error/Alert Log (EAL) screen area 166. As illustrated, the operations screen area 162 provides the user with an Operation button 168 to allow the user to perform device specific operations. A Maintenance button 170 is also provided to support functions such as software updates, backups and configuration information retrieval, etc. The operations screen area 162 also provides the user with a selection of functional buttons 172, 174, 176 that can be utilized to query the system for the status, reports, configuration information, etc. regarding one or more of the CTKs 10a-n by selecting the respective button 172, 174, 176.

The information screen area 164 displays the return information for a user's request. For example, the information screen area 164 may be used to display the device status request or the results from a report request. The EAL screen area 166 is used to display asynchronous CTK 10 errors and alerts to the user. For example, in FIG. 6, an alert is illustrated for CTK 10b located on the casino network 100 that notifies a user that one of the cassettes 44 (containing $10 bills in this example) is low on documents.

When a user connects to the management software 144 via a device (e.g., computer 120) within the casino network 100, the main window 160 will be displayed on the browser of the device. The user can then utilize the main window 160 to perform operations on the CTKs 10a-n in communication with the network 104. The ASP 146 will make the appropriate request to gather the data from the local memories 62 and/or the database 140 and then present the information to the user in the information screen area 164. The ASP 146 also updates the operations screen area 162 with the appropriate buttons or user selections as required. According to some embodiments, the ASP 146 is device independent, whereby all of the CTK 10 specific information is determined within the scope of the CTK 10 application's remote management extension code. According to some embodiments, the ASP 146 and the CTK's 10 application software interactions are accomplished using XML.

According to some embodiments, the management software 144 via the main window 160 allows the user to navigate throughout the interface in a drilldown fashion. As such, with each new level there is an increased level of device data resolution. According to some embodiments, the number of levels will be kept to a minimum, with 3-4 levels being typical for final data for a specific operation. This is accomplished by limiting the number of user configurable selections available on the management software 144 and by locating and customizing the management software's 144 main window 160 at a System Administrator level, which is supported by a system configuration tool.

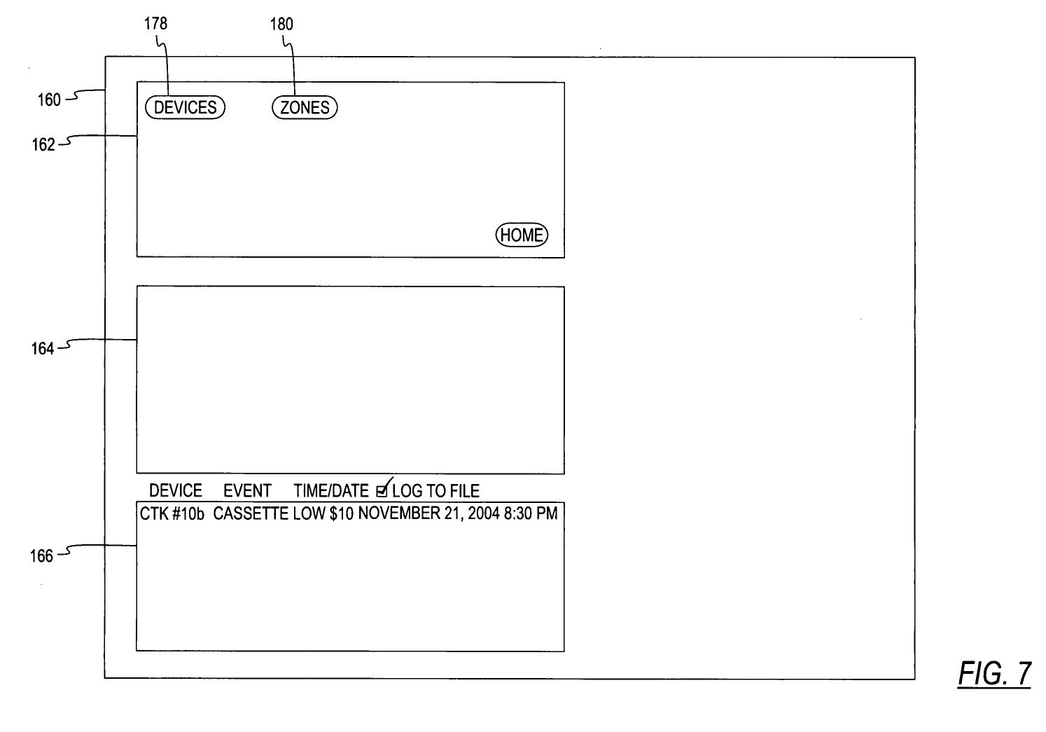

As discussed above, a user may monitor the status of one or more of the CTKs 10a-n within the casino network 100 by selecting the status button 172 from the operation screen area 162 of the main window 160. The ASP 146 then processes the request for status and creates and updates the main window 160 as illustrated in FIG. 7. In FIG. 7, the ASP 146 has adjusted the available operations in the operation screen area 162. For example, the user may now select either a Devices button 178 or a Zones button 180. By selecting the devices button 178 the user is able to view the CTK's 10a-n on the casino network 100, while selection of the zones button 180 allows the user to view a particular zone of CTK 10 devices. A zone may comprise a grouping of devices based in any number of ways, such as, for example, based on geographical placement, device type, etc.

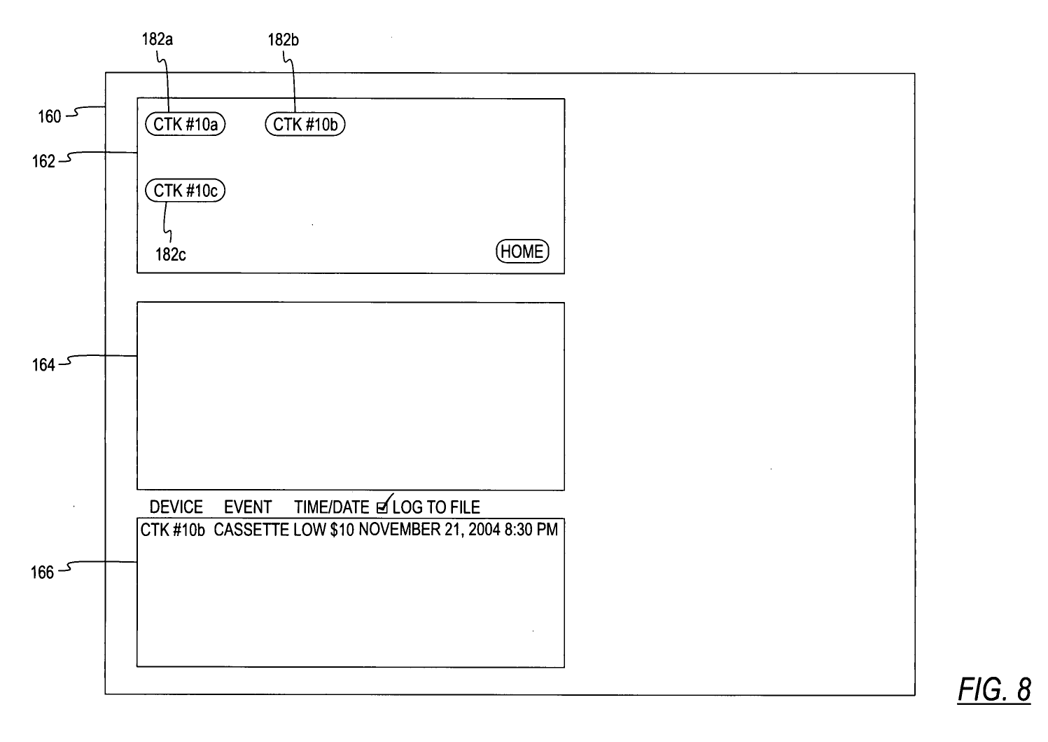

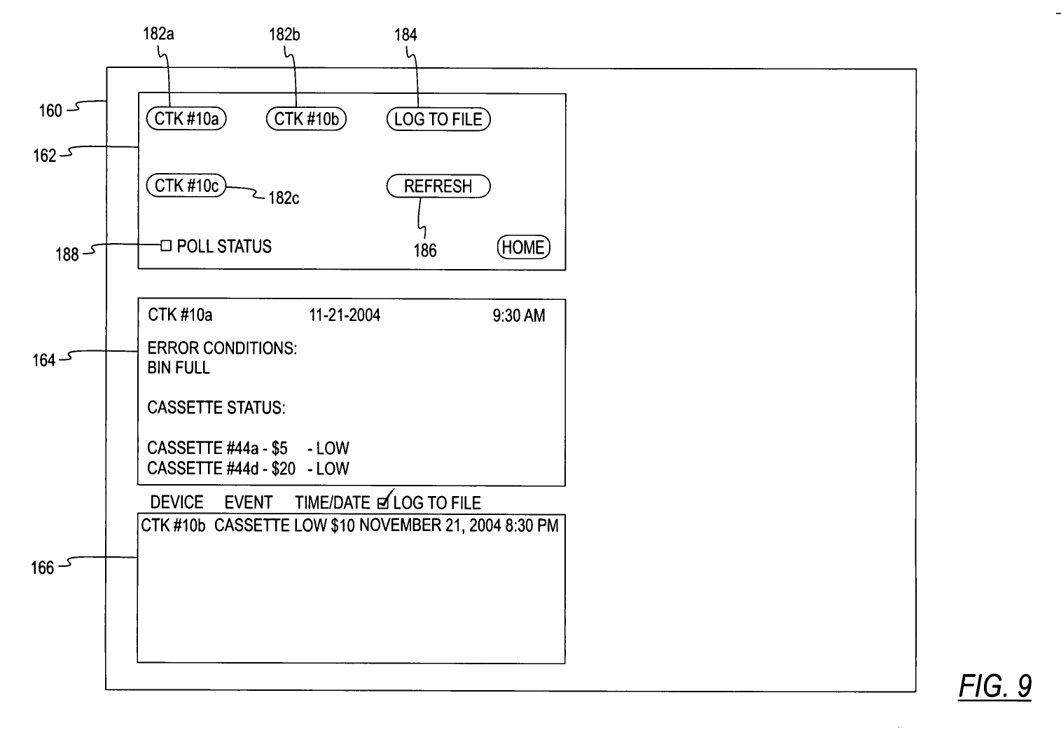

When the user selects the devices button 178, the ASP 146 determines the CTKs 10a-n located on the casino network 100 and modifies the main window 160 to display the located CTK's 10a-n, as illustrated in FIG. 8. The ASP 146 may also identify other devices using the same proprietary technology as the CTK 10, such as a self-service coin/token sorter, currency sorter, etc. The located CTKs 10a-n each have a respective device-selection button 182a-c to allow the user to select to perform a query on a particular machine. For example, when a user selects device-selection button 182a, the ASP 146 makes a request to the CTK 10a for the status. The ASP 146 processes the response from the request and updates the user's screen, as illustrated in FIG. 9. The device-selection buttons 182a-c operate in a toggle mode and the buttons 182a-c may be shaded, change color, etc., to indicate their current state to the user. The user can request the status on a single CTK 10, as illustrated in FIG. 9, or may request the status of multiple CTKs 10. Once a user has selected one or more of the device-selection buttons 182a-c, the user can obtain the current status for the selected CTKs 10a-n by selecting a Refresh button 186 located in the operation screen area 162. The refresh button 186 causes the ASP 146 to make another request to the desired CTKs 10a-n.

As illustrated in FIG. 9, the status of the CTK 10a is displayed in the information screen area 164. In the illustrated example, the CTK 10a has a “Bin Full” error condition, indicated that at least one of the CTK's 10a input bins is full with documents received from players. In addition, the CTK 10a has two cassettes 44a, 44d that are running low on documents—$5 and $20 currency bills as illustrated. The user may also select a Poll Status checkbox 188 to enable the automatic polling of the selected devices, whereby the selected devices are polled automatically when a specified period of time has passed from the previous status update (e.g., five seconds). The user may save the resulting status data to a file by selecting the Log to File button 184. When selected, the buffered data is saved to a file location specified by the user.

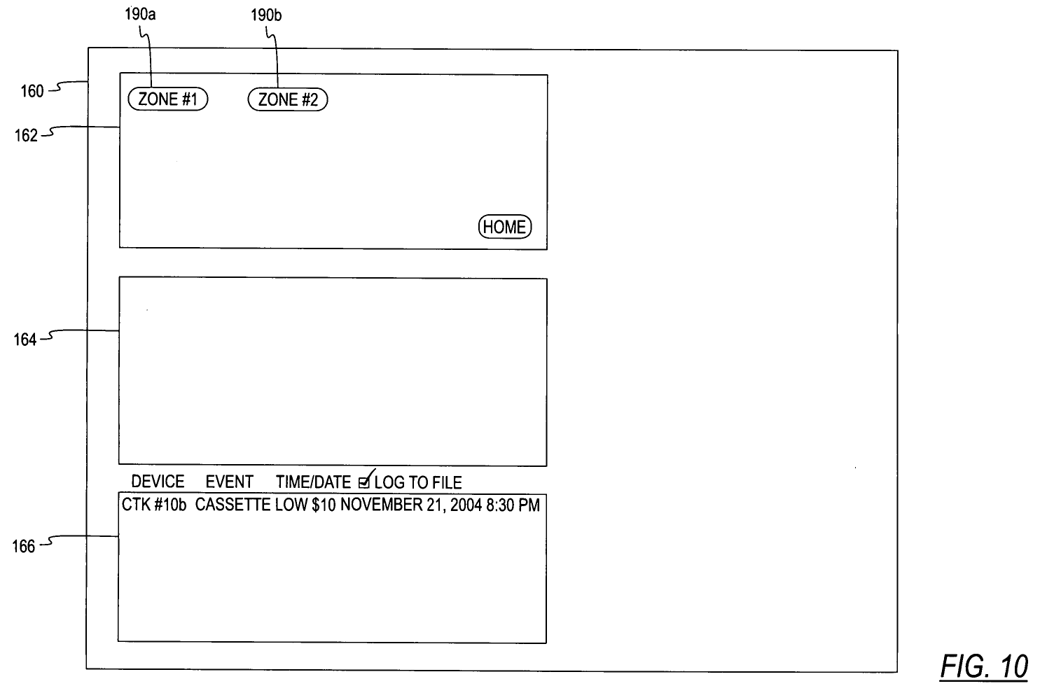

Referring again to FIG. 7, if a user selects the zones button 180 (as opposed to the devices button 178) the ASP 146 determines the zones of CTKs 10a-n located on the casino network 100. An individual zone may contain one or more CTK 10 or may be devoid of any CTKs 10. The ASP 146 then modifies the main window 160 based on the located zones, as illustrated in FIG. 10. Each located zone is provided with a zone-selection button 190. In the illustrated example, two zones have been located and thus, two zone-selection buttons 190a-b are provided.

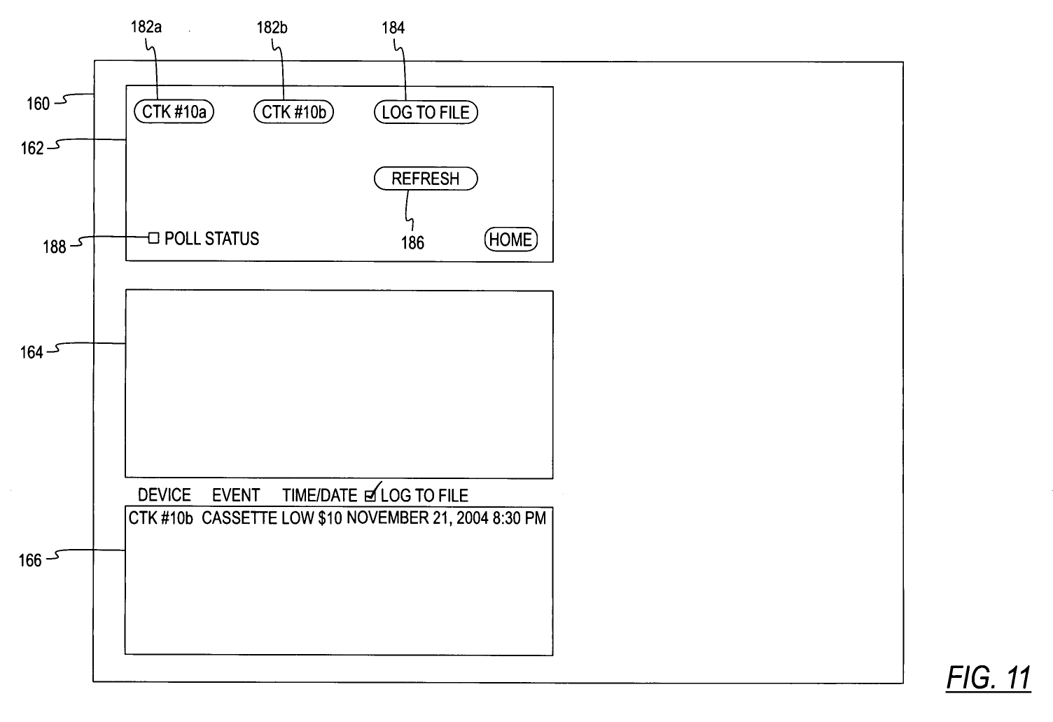

Referring now to FIG. 11, the user has selected to inquire about zone #1 by selecting the zone-selection button 190a in FIG. 10. As illustrated in FIG. 11, zone #1 contains CTKs 10a-b. The user may then query one or both of the CTKs 10a-b as discussed above with respect to FIG. 9. According to some embodiments, the management software 144 allows for the configuration of filtering for the different types of status reporting. Status filtering may be configured on either a device or zone level.

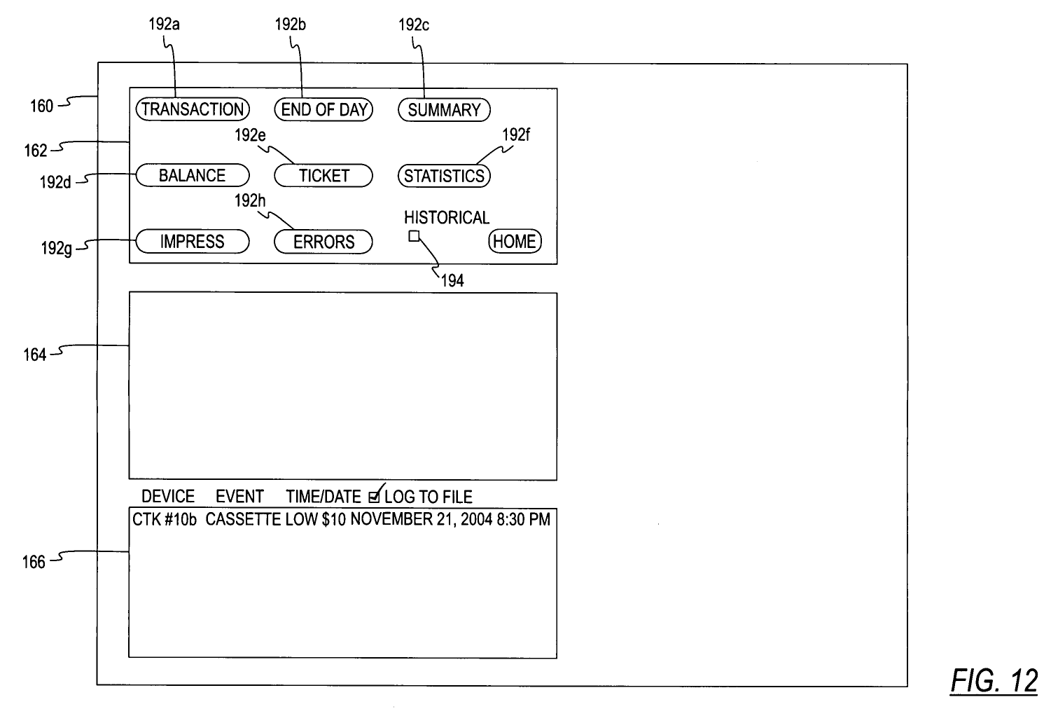

According to some embodiments, the management software 144 also allows a user to create a variety of reports (e.g., transaction detail, end-of-Day, summary, balance, impress, ticket, statistics, errors, etc.) based on the data collected from the CTKs 10a-n located on the casino network 100. Referring again to FIGS. 6-8, to begin the creation of a report, the user selects the reports button 174 from the operation screen area 162 in FIG. 6. The user then selects the devices button 178 from the operation screen area 162 in FIG. 7 and then selects one of the device-selection buttons 182a-c (FIG. 8) to produce a report for a particular CTK 10. As illustrated in FIG. 12, the user may now select from a plurality of report types by selecting one of the report-selection buttons 192a-f. For example, a transaction-detail report may be created to provide a reprint of a selected transaction by selecting the report-selection button 192a.

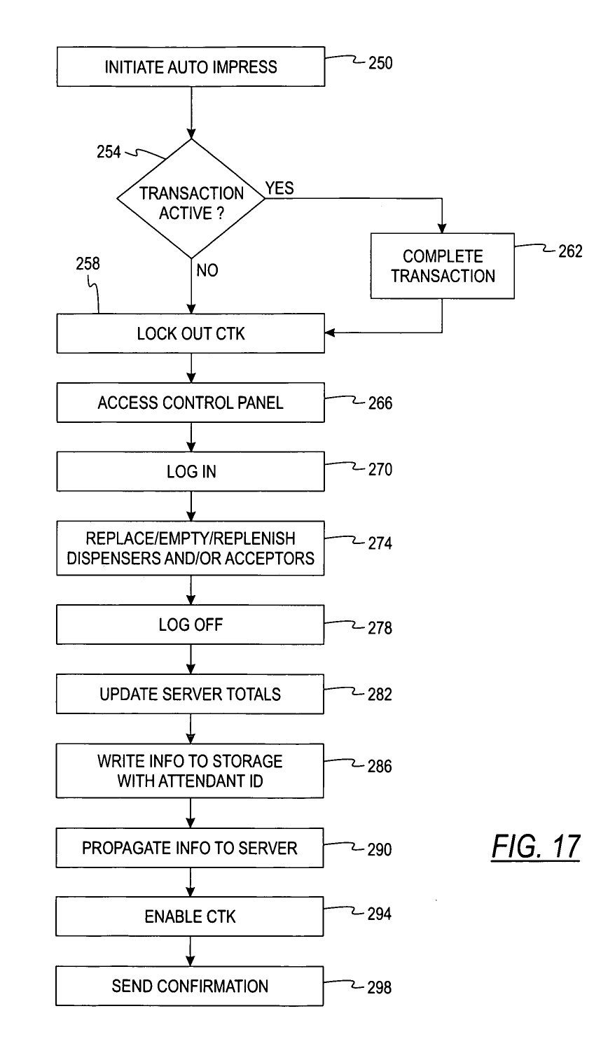

A transaction detail report contains all of the data from an original receipt (provided to an attendant by a CTK 10 during impress as will be detailed with respect to FIG. 17), except that it also includes a unique report title that distinguishes the report from the actual receipt. This helps to prevent the reprinting of a receipt for the purposes of fraud. According to some embodiments, the formatting of the transaction detail report is device specific and therefore, the actual formatting will be performed through a request of the CTK 10. The ASP 146 displays the returned data in the information screen area 164 of the main display 160. The report may then be printed into a hard copy by selecting a print button (not shown) that would be displayed in the operations screen area 162, along with buttons allow the user to log the report to a file and/or refresh the report.

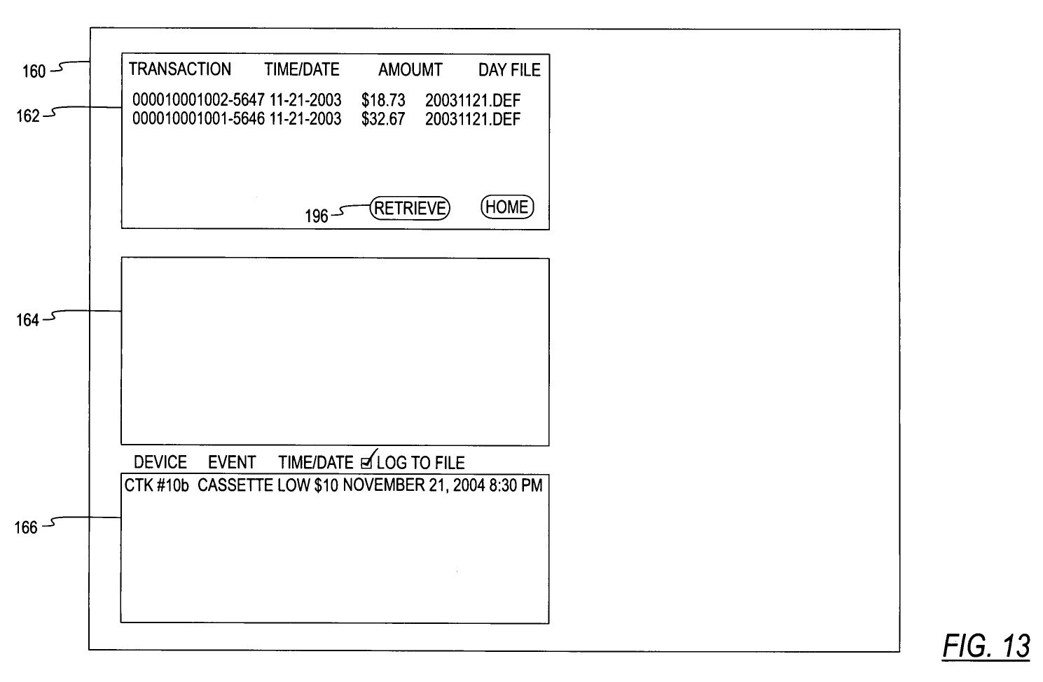

In some embodiments of the present invention, the report default is set to “immediate,” such that when a user requests a transaction detail report, the report will be generated for the most recent transaction. However, a transaction detail report may also be created for prior transactions by selecting the historical checkbox 194, in the operations screen area 162, prior to selecting one of the report-selection buttons 192a-f. When the historical checkbox 194 is checked and a device is selected, the ASP 146 makes a request of the selected CTK 10 or alternatively, or additionally, to the database 140. A listing of the historical transactions is then displayed in the operations screen area 162, as illustrated in FIG. 13. The user may then scroll through the historical transactions and select the particular transaction for which they desire a transaction detail report. Once the user has selected the transaction, the user can request the report by selecting a Retrieve button 196. Both the transaction list and the retrieve button 196 are located in the operations screen area 162 of the main window 160.

Various types of reports can be generated utilizing the management software 144 using a similar procedure to that described above. Examples of various reports are detailed further below but it should be understood that the reports that can be generated by the management software 144 are not limited to these examples. The management software 144 is capable of generating standardized reports or user-customized reports by querying the database 140 and/or storage 67. For example, an End-of-Day report can be generated by the management software 144. An End-of-Day report provides the totals from a CTK 10 from the start to the end of the Day. According to some embodiments, the formatting of the End-of-Day report, and other report types, is device specific. Therefore, the actual formatting is performed through a request of the CTK 10. The ASP 146 displays the returned data in the information screen area 164 of the main window 160.

A Summary report provides an abbreviated report of the CTK's 10 totals from the starting and closing points of a Day.

A Balance report provides a report of the CTK's 10 totals from the start of the current Day. The purpose of a Balance report is to provide a real-time snapshot of the CTK's 10 document handling components and to ensure that the CTK 10 is in balance.

An Impress report provides a report of the CTK's 10 acceptor and dispenser component totals at the time of the impress event. The Impress report provides a real-time snapshot of the CTK's 10 component totals. The Impress report provides the type and amount of documents loaded, dispensed, removed, and remaining in each of the individual cassettes 44a-f, each of the coin hoppers 45, and each of the acceptor boxes. An impress event can happen anytime a CTK 10 needs to be replenished or emptied. The impress event may be device specific or zone specific. Where the impress event is zone specific, an Zone Impress report may be generated.

A Ticket report can be generated by the management software 144 that provides the CTK's 10 ticket processing totals from the start of the current Day. The Ticket report provides the number of tickets processed, approved, and rejected, as well as the values associated with the tickets.

An Errors report can be generated to provide the CTK's 10 errors from the start of the current Day. This report may include historical errors too and thus, provides device specific error reporting with some long-term error history.

A Statistics report can be created to provide the CTK 10 statistics from the start of the current Day and will include non-resettable and resettable statistics too. The Statistics report provides device specific tracking data for trend analysis.

Trend analysis allows the casino to effectively and efficiently monitor and manage the CTKs 10a-n within the casino network 100. By analyzing the data collected from the individual CTKs 10a-n, a casino is able to develop a management plan for its casino network 100 and the CTKs 10a-n located therein. According to some embodiments, trend analysis allows a casino to evaluate the effectiveness of the geographic deployment of the CTKs. For instance, by tracking data variables such as average amount per transaction, average transaction type, average time between transactions, etc., the casino is better able to manage where additional CTKs 10 should be deployed and whether one or more of the current CTKs 10a-n need to by relocated.

Further, through the data analysis the casino may better be able to allocate its cash among the various CTKs 10a-n, which can assist in preventing excess “dead cash” from being maintained. Dead cash is an industry term for currency and coin that is sitting unused for an extended period of time. As an example, if a casino understands that in the past six months, every time a particular CTK 10 has been balanced, the CTK 10 has $50,000 in cash remaining in the cassettes, the casino can adjust its handling of the machine to free up this $50,000 in dead cash. The management software 144 tracks this type of information and reports it to a user. Additionally, based on the collected data, the management software 144 develops recommendations to alleviate the dead cash (and other) problems for the casino. In the above example, the management software 144 may recommend that the cassettes inserted into the particular CTK 10 contain less cash initially and/or that the machine be balanced less often (thus freeing up casino employees for other tasks). Thus, the management software 144 allows the casino to study consumer behavioral patterns over periods of time. This allows the casino to properly adjust its management scheme based on seasonality and other factors.

Trend analysis can also be used to determine the efficiency of marketing campaigns utilizing the CTKs 10a-n. For example, once an advertisement or promotion involving coupons (e.g., 20% off at the buffet) has been scheduled, the management software 144 can track the number of coupons dispensed by the individual CTKs 10a-n. The management software 144 also communicates with third-party components used to redeem the coupons, such as a bar code scanner at the buffet, to determine the number of coupons that have been redeemed and from which CTK 10a-n they were dispensed. The marketing department can then use this information to determine which CTK's 10a-n are most effective for a particular marketing campaign. In the future, the marketing department may then utilize these CTKs 10 to promote the buffet, while utilizing the other CTKs 10 to provide other promotions. Thus, each individual CTK 10a-n can provide advertisements and promotions where the advertisements are the most effective.

Further, trend analysis allows the casino to determine the typical device utilization to better manage the individual CTKs 10a-n. For example, if the management software 144 determines that a typical transaction on a particular CTK 10 involves several unnecessary steps, the management software can provide a recommendation to the casino to adjust the particular machine. For instance, a typical transaction may be found to begin with a player scanning their player's card and requesting $250 be deducted from the card. The CTK 10 may then be programmed by the casino to provide a mix of currency to the player, such as two $100 bills and one $50 bill. It may then be found to be typical that the player reinserts one of the $100 bills and requests a bill break resulting in the user receiving five $20. The user may then typically end his or her transactions at the CTK 10. Thus, the management software would determine that a typical transaction involves removing an amount of money from the card, receiving the amount in currency, and then reinserting a portion of the received currency to break the currency into smaller denominations.

In the above example, the management software 144 determines that in the typical transaction, two steps are typically being performed by a player at the CTK 10. Because a casino desires to minimize the time spent by players on the CTKs 10a-n (to allow more players to be serviced by a particular CTK 10) the software management 144 provides the casino with a recommendation to adjust the mix of currency being initially dispensed from the machine. For example, the management software 144 can recommend that the initial mix for a $250 withdrawal be distributed as one $100 bill, one $50 bill, and five $20 bills. The casino may then utilize the management software 144 to reconfigure the CTK 10 to provide this mix initially, thus saving a player's time and freeing up the CTK 10 faster. This analysis can be performed on an individual player-by-player basis or on a more generalized basis such as a determination of what particular payout configuration is most frequently requested by players or players using CTKs 10 in a particular zone.

In addition, trend analysis can be utilized by the casino to determine when maintenance is required on a particular CTK 10. This enables the casino to take a proactive approach and get maintenance prior to the CTK 10 becoming non-functional. This also allows the casino to note upcoming maintenance requirements and budget for these costs. For example, if a CTK 10 requires a component to be replaced or cleaned after 100,000 transactions, the management software 144 may periodically query the database 140 to determine the number of transactions that have occurred on the CTK 10. The management software 144 may then send a recommendation to schedule maintenance for a particular CTK 10 when the CTK 10 has performed 95,000 transactions.

Trend analysis can also be utilized by a casino to determine the typical amount per transaction on an individual or group of CTKs 10a-n. This same analysis can be used to establish both the uptime and downtime of a particular CTK 10 (of group thereof) as well as a percentage distribution of reasons for the downtime (e.g., maintenance, impress procedures, errors, etc.). Trend analysis can provide information as to the percentage distribution of errors on a particular CTK 10 (or group thereof) as well. This type of information allows a casino to determine the most common error(s) on the CTKs 10a-n and properly attend to the situation.

Trend analysis can be used to determine the standard CTK 10 cashflows, helping to alleviate the dead cash problem described above. Similarly, the amount of documents collected for bill breaking functions and the number of tickets redeemed over a period of time can be analyzed utilizing the management software 144. Additionally, the frequency of transactions on one or more of the CTKs 10a-n can be monitored. This allows the casino to enable or disable particular functionalities based on the expected player needs.

Further, trend analysis can be utilized to determine the number of player tracking transactions (e.g., how many points have accumulated on a player's card, etc.) and the number of informational transactions (e.g., casino restaurants and menus, shows and time information, etc.) that have been performed on one or more of the CTKs 10a-n. The management software 144 can be utilized to determine the trends in usage patterns among the various departments within a casino (e.g., accounting, marketing, IT, etc.). In addition, the amount of data collected on one or more of the CTKs 10a-n can be analyzed utilizing the management software 144.

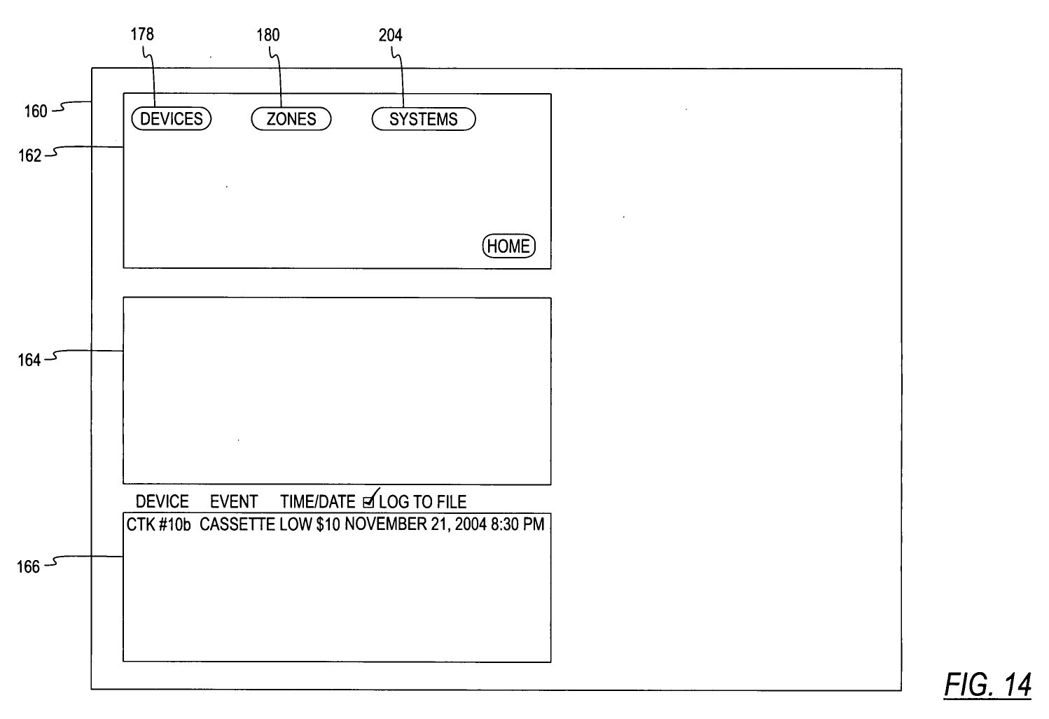

The management software 144 can also be utilized to configure the CTKs 10a-n located on the casino network 100. The user may backup, recover, create, modify, and delete device configuration files from within the management software 144. Referring again to FIG. 6, a user can configure one or more of the CTKs 10a-n by selecting the configuration button 176. Once the user has selected the configuration button 176, the user is prompted to select between the devices button 178, the zones button 180, and a Systems button 204, as illustrated in FIG. 14. The systems button 204 allows a user to configure all of the CTKs 10a-n located within the casino network 100 simultaneously, while the devices and zones buttons 178, 180 allow the user to configure specific CTKs 10a-n or particular groups thereof.

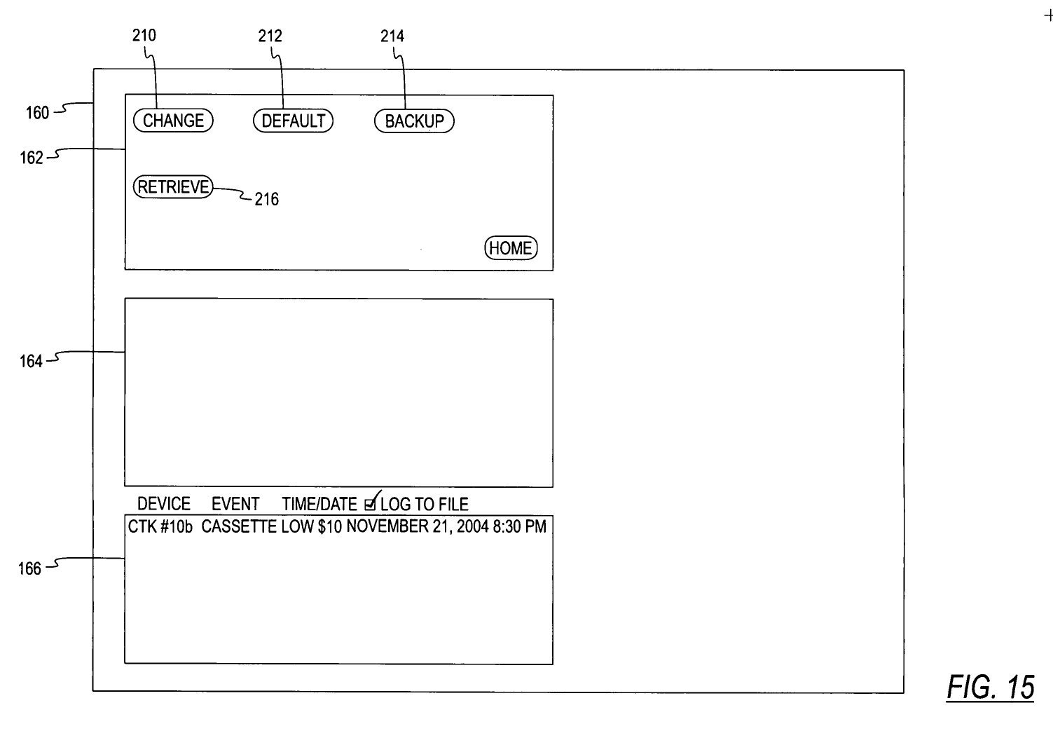

Once a user has selected one or more of the CTKs 10a-n to configure, the ASP 146 generates a plurality of operation buttons for the user to utilize, as illustrated in FIG. 15. The user must have the appropriate access privileges to gain entry to the system and device configuration editing tools. Once granted access, the user may select from a Change button 210, a Default button 212, a Backup button 214, and a Retrieve button 216 to edit the device or system configuration settings.

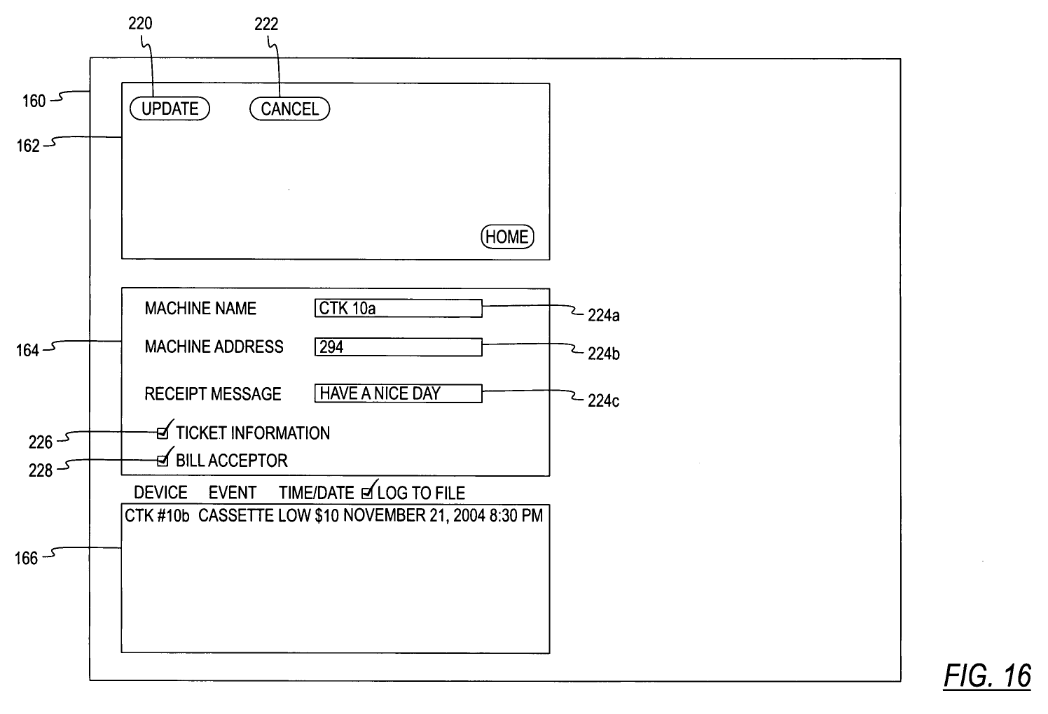

When the user selects the Change button 210, a fields-based editor is presented to the user in the information screen area 164, as illustrated in FIG. 16. The user may then manually adjust the properties of a plurality of individual fields 224a-c to reconfigure the selected CTK 10a. Additionally, the user may select whether the CTK 10a is to be used as a ticket interface, bill acceptor, or both, by utilizing checkboxes 226, 228. In addition, additional checkboxes can be utilized to enable or disable some or all of the CTK 10 functionalities available to the player. The ASP 146 determines which configuration functions are allowed for the current user. Typically, the user has an access level assigned to them that determines the functions they are allowed to utilize.

Once the user has edited the information within the fields or selected or deselected one of the checkboxes 226, 228, the user may then update the configuration by selecting a Update button 220 located in the operations screen area 162 or may cancel the changes by selecting the Cancel button 222. If the user selects the update button 220, the changes are then electronically journaled and maintained for future reference. The electronic journal files are stored in a secured directory within the database 140.

According to some embodiments, the management software 144 provides a backup utility for system configuration files. The management software 144 can query the devices for their configuration information and save the results to the database 140 for later use. According to some embodiments, the management software 144 also allows a user to default to a known set of parameters or to a previous configuration backup.

The management software's 144 abilities—including the ability to configure the CTKs 10a-n—are available to a plurality of users having access to a web browser. For example, as discussed above, users are able to view and obtain reports regarding the financial status of the CTKs 10a-n. This type of information can be accessed by a casino accountant using a computer in the accounting office. At the same time, a user in the marketing department can access the configuration tool to configure the CTKs 10a-n to display a specific marketing audio/video file when the CTK 10 is not in use by a player. This can be performed from a computer in the marketing department having a browser and a network connection. Further, the casino floor attendant can query the CTKs 10a-n to determine whether they need to be balanced or replenished. This can be performed from a network computer separate from the accounting and the marketing departments.

In some embodiments, the IT department of the casino is provided the privileges necessary to configure the security of the CTKs 10a-n and the management software 144. The IT department can be provided the privileges to add, modify, and/or remove users from the system. Additionally, the IT department can establish, modify, and/or remove passwords associated with the various users. The IT department can also establish a user's rights and privileges within the system, as well as modify or remove their privileges.

According to some embodiments, the management software 144 provides support for software and database operations through the maintenance button 170 (FIG. 6). Access to functions through the maintenance button 170 are treated as secured functions—requiring the user to have the appropriate access level assignments. All maintenance operations are electronically logged and can be reviewed by the appropriate users. The management software 144 supports the backing up, updating, and restoration of software and database operation from both external and local sources. The maintenance software 144 allows the server's 116 and CTK's 10 operation configuration data and all associated database files to be able to be backed up both manually and via a scheduled mechanism. Multiple server 116 and CTK 10 backups are maintained and may be purged based on the purge settings (e.g., after a set time period, after a predetermined number of subsequent backups are saved, etc.).

The management software 144 allows for the updating of the server 116 and CTK 10 software. According to some embodiments, the user has the ability to abort the update and revert to the previous version of the software and operating environment at any time during the update. The update process consists of three primary update steps. First, the server's 116 operating environment is saved. Next the new operating environment is staged and finally the CTK 10 is switched from its current environment to the server 116. The management software 144 also allows for the restoration of a previous version of software and operating environment for the server 116 and CTK 10. The management software 144 determines if there are any compatibility issues with existing CTKs 10a-n within the casino network 100 before it allows a restoration to occur. If any incompatibilities are determined between the restoration and existing networked CTKs 10a-n, the management software 144 provides this feedback to the user.

According to some embodiments, the management software 144 further provides support for server 116 and CTK 10 operations through the operations button 168 (FIG. 6). As with the maintenance functions described above, access to functions through the maintenance button 170 are treated as secured functions-requiring the user to have the appropriate access level assignments. Through the operations button 168, a user can determine server 116 and CTK 10 operations such as, a list of user's logged into the system, a list of networked CTKs 10a-n, CTKs 10 On/Off line, CTK 10 diagnostic test results, CTK 10 device debug mode, etc.

According to some embodiments, the management software 144 also provides support for server 116 and CTK 10 transaction management. The management software 144 provides (i) an interface with third-party transaction processors, (ii) the necessary operations for auto-impressing the CTK 10, and (iii) mechanisms for transaction auditing. Further, in some embodiments, the management software 144 provides support for escalated error reporting and provides the ability to (i) configure specific errors for special handling, (ii) notify external entities via a pager, e-mail, or other system, and (iii) send messaging that can be handled via a text-to-speech processor.

Turning now to FIG. 17, a method for remote, auto-impressing the CTK 10 is illustrated, according to one embodiment of the present invention. To initiate the auto-impress, a casino may utilize the management software 144 to schedule or initiate the balancing of an individual CTK 10 (or zone or user-selected grouping thereof), at step 250. Once a CTK 10 receives the impress command, the CPU 60 of the CTK 10 determines, at decision box 254, whether a transaction is currently being processed by the CTK 10. If the CTK 10 is not performing a transaction, the CTK 10 is locked out from performing further player transactions at step 258. Alternatively, if a transaction is being processed, the transaction is completed, at step 262, and then the CTK 10 is locked out at step 258. The attendant responsible for replenishing and/or emptying of the CTK 10 accesses the attendant control panel 42, at step 266, and utilizes the control panel 42 to log in to the CTK 10 at step 270. Then, at step 274, the attendant then either (i) replaces one or more of the cassettes 44a-f, (ii) empties and then replenishes one or more of the coin hoppers 45, (iii) replaces one or more of the acceptor boxes, or (iv) performs some combination of options (i) through (iii). Once the attendant has replaced or replenished at least one of the components, the attendant logs off of the CTK 10 at step 278. Steps 270 through 278 are the only steps that require an attendant to interact with the CTK 10.

Once the attendant has logged off from the CTK 10, the impress amounts inserted into the CTK 10 are updated to the server 116, at step 282. The impress information is written to the local memory 62, such as to the storage 67, along with the attendant's identification information, at step 286. According to some embodiments, the impress information includes the cash amount loaded, removed, dispensed, diverted, removed from the divert, etc. The impress information may also include the number of tickets removed, value of tickets removed, or other information. The impress information is then propagated to the server 116 along with the attendant's ID information, at step 290. Once the server 116 has received this information, the management software 144 enables the CTK 10, at step 294, and sends an impress complete confirmation to the user requesting the impress (if any), at step 298. Alternatively, the management software 144 sends a confirmation to the database 140.

While the invention is susceptible to various modifications and alternative forms, specific embodiments thereof have been shown by way of example in the drawings and are described in detail herein. It should be understood, however, that it is not intended to limit the invention to the particular forms disclosed, but, to the contrary, the intention is to cover all modifications, equivalents and alternatives falling within the spirit and scope of the invention as defined by the appended claims.

1. A networked cash dispensing system comprising:
a casino transaction kiosk having one or more input and output being adapted to receive and dispense documents, the casino transaction kiosk further having a central processing unit adapted to operate the kiosk and a local memory adapted to store information thereon;
a server having a database and management software including a data mining software portion and a user interface software portion therein, the database being adapted 10 to store information thereon, the management software being adapted to interact with the casino transaction kiosk, the data mining software portion being adapted to query the database; and
a network in communication with the casino transaction kiosk and the server, the network being adapted to allow the casino transaction kiosk and the server to communicate,
wherein the system is adapted to transfer a portion of the information stored on the local memory of the casino transaction kiosk to the database of the server and the management software is adapted to analyze this information.

2. The networked cash dispensing system of claim 1, wherein the information is analyzed to determine trends regarding casino transaction kiosk usage.

3. The networked cash dispensing system of claim 1, wherein the information is analyzed to determine the effectiveness of the geographic deployment of the casino transaction kiosk.

4. The networked cash dispensing system of claim 1, wherein the information is analyzed to determine the average amount of dead cash contained within the casino transaction kiosk.

5. The networked cash dispensing system of claim 1, wherein the management software initiates a balancing procedure by the casino transaction kiosk.

6. The networked cash dispensing system of claim 5, wherein the management software and casino transaction kiosk automatically balance the casino transaction kiosk.

7. The networked cash dispensing system of claim 1 further comprising a coaxial cable adapted to provide a signal feed, the casino transaction kiosk including a coax-cable input adapted to be coupled to the coaxial cable.

8. The networked cash dispensing system of claim 7, wherein the casino transaction kiosk further includes a video display and a television expander card, the television expander card being adapted to relay the feed from the coaxial cable at the coax-cable input to the video display.

9. The networked cash dispensing system of claim 7, wherein the coaxial cable provides a television signal feed to the coax-cable input.

10. A method for trend analysis within a casino network, a casino transaction kiosk being coupled to the network, the casino transaction kiosk having one or more input and output being adapted to receive and dispense documents, at least one of the one or more outputs being adapted to dispense a plurality of documents from a plurality of document-containing cassettes, the casino transaction kiosk further having a central processing unit adapted to operate the kiosk and a local memory adapted to store information therein, the network further being coupled to a server having a database and management software including a data mining software portion and a user interface software portion therein, the database being adapted to store information thereon, the management software being adapted to interact with the casino transaction kiosk, the data mining software portion being adapted to query the database, the casino transaction kiosk and the server being communicatively coupled to each other via the network, the method comprising:
the act of transmitting information from the local memory of the casino transaction kiosk to the database on the server; and
the act of analyzing the transmitted information contained in the database to determine usage statistics over a duration of time for the casino transaction kiosk.

11. The method of claim 10, wherein the usage statistics include an average of the amount of currency per transaction.

12. The method of claim 10, wherein the usage statistics include an average of the transaction type.

13. The method of claim 10, wherein the usage statistics include an average of the time between transactions.

14. The method of claim 10, wherein the usage statistics include an average of the number of documents remaining in each of the plurality of document-containing cassettes.

15. The method of claim 10, wherein the usage statistics include an average of the amount per transaction.

16. The method of claim 10, wherein the usage statistics include an uptime percentage for the casino transaction kiosk.

17. The method of claim 10, wherein the usage statistics include a downtime percentage for the casino transaction kiosk.

18. The method of claim 17, wherein the usage statistics further include a percentage distribution of the reasons for the downtime.

19. The method of claim 10, wherein the usage statistics include a percentage distribution of errors.

20. The method of claim 10, wherein the usage statistics include a cashflow analysis for the casino transaction kiosk.

21. The method of claim 10, wherein the usage statistics include a frequency of transactions statistic.

22. The method of claim 10, wherein the usage statistics include an operations usage pattern for the casino transaction kiosk.

23. The method of claim 10, wherein the usage statistics include an amount of collected data statistic.

24. The method of claim 10, wherein the usage statistics include an amount of tickets redeemed over a period of time.

25. The method of claim 10, wherein the usage statistics include an amount of currency accepted for bill breaking.

26. The method of claim 10, wherein the usage statistics include an average number of player tracking transactions.

27. The method of claim 10, wherein the usage statistics include an average number of informational transactions.

28. The method of claim 10, wherein the usage statistics include statistics relating to a marketing campaigns effectiveness.

29. A cash dispensing system comprising:
a casino transaction kiosk having at least one input being adapted to receive documents and at least one output being adapted to dispense documents, the casino transaction kiosk further having a local memory adapted to store information thereon, the casino transaction kiosk being controlled by a central processing unit adapted to operate the kiosk;
a server having a database and management software including a data mining software portion and a user interface software portion therein, the database being adapted to store information thereon, the management software being adapted to interact with the casino transaction kiosk, the data mining software being adapted to query the database; and
wherein the system is adapted to transfer a portion of the information stored on the local memory of the casino transaction kiosk to the database of the server and the management software is adapted to analyze this information.

30. The cash dispensing system of claim 29, wherein the information is analyzed to determine trends regarding casino transaction kiosk usage.

31. The cash dispensing system of claim 29, wherein the information is analyzed to determine the effectiveness of the geographic deployment of the casino transaction kiosk.

32. The cash dispensing system of claim 29, wherein the information is analyzed to determine the average amount of dead cash contained within the casino transaction kiosk.

33. The cash dispensing system of claim 29, wherein the management software initiates a balancing procedure by the casino transaction kiosk.

34. The cash dispensing system of claim 33, wherein the management software and casino transaction kiosk automatically balance the casino transaction kiosk.

35. The cash dispensing system of claim 29 further comprising a coaxial cable adapted to provide a signal feed, the casino transaction kiosk including a coax-cable input adapted to receive the coaxial cable.

36. The cash dispensing system of claim 35, wherein the casino transaction kiosk further includes a video display and a television expander card, the television expander card being adapted to relay the feed from the coaxial cable at the coax-cable input to the video display.

37. The cash dispensing system of claim 35, wherein the coaxial cable provides a television signal feed to the coax-cable input.

38. A method for remote auto-impressing a casino transaction kiosk within a casino network, the casino transaction kiosk having at least one input being adapted to receive documents and transfer the received documents to an acceptor and at least one output being adapted to dispense documents from a dispenser, the casino transaction kiosk having a control panel adapted to be logged into manually by an attendant, the casino transaction kiosk further having a local memory adapted to store information thereon, the casino transaction kiosk being controlled by a central processing unit adapted to operate the kiosk, the network further being coupled to a server having a database and management software, the database being adapted to store information therein, the management software being adapted to interact with the casino transaction kiosk, the casino transaction kiosk and the server being communicatively coupled to each other via the network, the method comprising:
the act of initiating an auto-impress procedure utilizing the management software;
the act of locking out the casino transaction kiosk, the act of locking out of the casino transaction kiosk being performed by the management software;
the act of logging into the casino transaction kiosk via the control panel, the act of logging in being performed by an attendant by supplying attendant information;
the act of replacing one or more receptacle or cassette associated with the one or more acceptor and dispenser;
the act of logging off from the casino transaction kiosk via the control panel, the act of logging off being performed by an attendant;
the act of balancing the casino transaction kiosk after the attendant has logged off, the act of balancing being performed by the management software; and
the act of enabling the casino transaction kiosk, the act of enabling the casino transaction kiosk being performed by the management software after the attendant has logged off.

39. The method of claim 38 further comprising the act of updating the information stored in the database of the server after the attendant has logged off, the act of updating being performed by the management software.

40. The method of claim 39 further comprising the act of writing attendant information to the database of the server along with the updated information.

41. The method of claim 38 further comprising the act of sending a confirmation that the auto-impress procedure has been completed after enabling the casino transaction kiosk.
